(19) United States
(12) Patent Application Publication
(10) Pub. No.: US 2015/0024100 A1
(43) Pub. Date: Jan. 22, 2015

(54) PORTABLE OIL FILTERING APPARATUS

(71) Applicant: Peter Alan Bell, Queensland (AU)

(72) Inventor: Peter Alan Bell, Queensland (AU)

(21) Appl. No.: 13/960,921

(22) Filed: Aug. 7, 2013

(30) Foreign Application Priority Data
Jul. 18, 2013 (AU) 2013207615

(51) Int. Cl. B01D 35/26

(52) U.S. Cl. CPC B01D 35/26
USPC 426/417; 210/241

(57) ABSTRACT

The present invention is a portable oil filtering apparatus that can operate independent of external power sources to collect oil from cookers or fryers for disposal or storage and filter oil from the cookers or fryers for re-use. The oil filtering apparatus of the preferred embodiment is able to collect and dispose of oil in a safe and efficient manner. The oil filtering apparatus of the preferred embodiment is able to filter oil to remove particulate matter and other contaminants and reintroduce the filtered oil to a cooker and fryer thereby extending the operational life of the oil. In this way the preferred embodiment of the oil filtering apparatus is able to recycle oil from cookers and fryers and thereby save money and reduce the amount of waste oil released into the environment.

### CROSS-REFERENCE TO RELATED APPLICATION

This application claims the priority filing benefit of Australian Patent Application No. AU 2013207615 filed Jul. 18, 2013.

### FIELD OF INVENTION

The present invention relates to an apparatus for filtering oil and storing oil. The present invention has particular but not exclusive application for filtering and storage of oil for use in deep fryers and cookers. Reference in the specification to the use of the apparatus for collecting oil from fryers and cookers is by way of example only and the invention is not limited to this particular use.

### BACKGROUND OF THE INVENTION

Deep fry cooking of foods is a popular method of cooking take-away or fast foods. The cooking of the food is relatively quick compared with other types of cooking. Generally, cooking occurs at a frying temperature of approximately 175° C. to 190° C. The food is generally coated in batter or bread crumbs prior to cooking and the coating forms a protective layer during cooking, preventing oil from penetrating the food and making it greasy. The food will usually cook by conduction or indirect heat. If the oil is not hot enough, the coating will not cook quickly enough to form a protective layer. If the oil is too hot, the coating will burn from the direct heat of the oil before the food has had time to cook.

Furthermore, the oil degrades with use lowering the smoke point of the oil to a level where adequate deep frying temperatures cannot be maintained. The smoke point of the oil is the temperature at which the oil begins to degrade and visible fumes of smoke are released. Degradation occurs due to lowering of the un-saturation levels of the oils. This degradation is promoted by the presence foreign matter in the oil such as bread crumbs, batter, salt and other food debris. The useful life of the cooking oil will depend on the temperatures to which the oil is heated, the number of times the oil is used and the length of time the oil is heated.

Because oil is degraded with use, the quality of oil in deep fryers and cookers should be monitored to maintain the quality of the fried food produced. Maintenance of oil quality may be achieved by removing and discarding the used oil from the fryer and replacing it with fresh oil. However, the lifetime of the oil can be prolonged by regular filtering to remove debris which promotes oil degradation. This is achieved by removing the oil from the fryer, filtering whilst hot and returning to the fryer.

The minimum recommended operating temperature for filtering the oil is approximately 120° C. degrees. At lower temperatures the oil is too viscous to allow effective filtration of the impurities from the oil. Furthermore, commercial filter aid powders which assist in clarification of the oil are only intended for use at temperatures in excess of 100° C. The removal of the hot oil from the fryer or cooker is potentially dangerous as the oil can spill or splash and cause serious burns to a person.

Fryers generally have an oil drain at the base of the fryer. For safety and convenience it is preferable to position the apparatus under the fryer with the oil inlet aligned with the oil drain so that the used oil can drain directly into the oil inlet. The size and volume of fryers varies. In addition the space available under fryers can also vary and access may be limited making it difficult to position existing oil filtration apparatus under the oil drain.

Furthermore, due to the environment in which oil filtering apparatus is used, the filtering apparatus is prone to malfunction or failure due to the effects of oil spillages and exposure to heat. This can result in down time while the apparatus undergoes repair or maintenance.

### OBJECT OF THE INVENTION

It is an object of the present invention to provide an alternative means for removing oil or filtering oil for reuse from cookers and fryers and overcoming at least in part one or more of the abovementioned disadvantages.

### SUMMARY OF THE INVENTION

The present invention has been developed to make a more robust and versatile oil filtering apparatus while minimizing the possibility of accidents and misuse by operators.

In one aspect the present invention broadly resides in a portable oil filtering apparatus, including:

a tank with a plurality of wheels; said tank has an inlet for receiving used oil from an oil source, a filter means to filter the used oil and a discharge outlet for discharging the filtered used oil;

a control tower mountable to the tank; said control tower has a pump means to pump the filtered oil from the tank discharge outlet and a control means to control the operation of the pump means;

wherein the control means includes two separate power means to power the pump means, a first power means includes at least one battery operationally connected to the pump means and a second power means includes a mains power connection via a transformer to the pump means; wherein the control tower and tank are modular units that can be assembled to meet desired requirements and or provide replacement units.

The control tower is preferably mountable to the rear of the tank.

The inlet for receiving used oil is preferably at or near the front of the tank.

The control tower is preferably mountable to the rear of the tank and is operatively associated with each other when the tank discharge outlet is operatively connected to the pump means.

The filter means preferably includes one or more filters at or adjacent the opening of the inlet. In a preferred form, the filter means includes a frame that supports a heat resistant polymer mesh filter with 100 to 60 micron pore size. Preferably, the polymer filter has a pore size of approximately 80 microns. The filter means preferably includes one or more filters at or adjacent an opening of the inlet, and the filter means includes a frame with a heat resistant polymer mesh filter having 60 to 100 micron pore size.

In use the frame is positioned on and over the opening of the inlet and the filter extends within the interior of the tank. Where further filtering is required, for example to remove fine particulate matter, a second polymer mesh filter is positioned on the frame on the outside of the initial polymer filter. The second polymer mesh filter preferably has a pore size that is smaller than the pore size of the initial polymer filter. Preferably the second polymer mesh filter has a pore size of approximately 60 microns.

In another preferred embodiment, the filter means includes a mesh grate supporting a paper filter. The paper filter is preferably used in conjunction with a filter aid such as diatomaceous earth. The filter aid can be used to form a filter pad on the paper filter, or can be added to the oil before filtration. The mesh grate is positioned below the opening of the inlet and preferably serves to filter particulate matter in the oil.

The tank preferably has a sump and the sump is separated from the rest of the tank by a sump grate.

The tank preferably has a sump and the sump is separated from the rest of the tank by a sump grate, the tank discharge outlet includes a pipe that extends from the sump and is operatively connected to the pump means.

In one aspect the present invention broadly resides in a portable oil filtering apparatus, including:

a tank with a plurality of wheels; said tank has an inlet for receiving used oil from an oil source, a filter means to filter the used oil and a discharge outlet for discharging the filtered used oil;

a control tower mountable to the tank; said control tower has a pump means to pump the filtered oil from the tank discharge outlet and a control means to control the operation of the pump means; wherein the control means includes two separate power means to power the pump means, a first power means includes at least one battery operationally connected to the pump means and a second power means includes a mains power connection via a transformer to the pump means; wherein the filter means includes one or more filters at or adjacent the opening of the inlet, the filter means includes a frame that supports a polymer filter with 100 to 60 micron pore size; wherein the control tower and tank are modular units that can be assembled to meet desired requirements and or provide replacement units.

The filter means preferably includes a sump grate with perforations having a diameter between 1 mm and 2 mm. Preferably, the sump grate has perforations with a diameter that is substantially 1.5 mm. The sump grate is preferably positioned over the opening to the sump. Preferably the sump grate is removable for cleaning purposes. Preferably there is a pipe or coupling that extends from the sump to above the tank and can provide fluid communication between the sump and the control tower for discharging filtered oil.

Said pump means preferably includes a DC electrical motor operatively connected to a pump. The pump means preferably includes a hose operatively associated with the pump for discharging filtered oil. The second power means preferably transforms AC current from mains power to DC current to operate the pump means and charge the at least one battery, the pump means includes a DC electrical motor operatively connected to a pump. Preferably mains power between 110v and 240v can be used and be transformed to DC current.

The control means preferably includes a processor means operatively associated with one or more batteries and the motor. The processor means preferably includes circuit board controls and a transformer for converting AC current to DC current. Preferably the control means includes Wi-Fi communication means, General Packet Radio Service (GPRS) means and/or Global Positioning System (GPS) means. The processor means is preferably actuated by a touch pad. The touch pad is preferably resilient and water, oil and chemical resistant. The touch pad keys preferably include on, off, fast and slow keys. The touch pad keys preferably include a backwash key. The backwash key preferably only operates when a person keeps their finger pressed on the backwash key. The touch pad preferably includes a battery charge indicator.

Preferably the control tower includes an AC power socket for connection to mains power supply. The control tower preferably includes an antenna to facilitate Wi-Fi communication, GPRS communication and/or GPS communication.

Preferably the Wi-Fi communication or GPRS communication provides remote access to the oil filtering apparatus. With remote access, the location of the oil filtering apparatus, a log of filtration events and/or remote diagnosis is preferably available. Preferably, the oil filtering apparatus can be turned on or off remotely via Wi-Fi communication or GPRS communication.

In another aspect the present invention broadly resides in a portable oil filtering apparatus, including:

a tank with a plurality of wheels; said tank has an inlet for receiving used oil from an oil source, a filter means to filter the used oil and a discharge outlet for discharging the filtered used oil;

a control tower mountable to the tank; said control tower has a pump means to pump the filtered oil from the tank discharge outlet and a control means to control the operation of the pump means; wherein the control means includes two separate power means to power the pump means, a first power means includes at least one battery operationally connected to the pump means and a second power means includes a mains power connection via a transformer to the pump means; wherein the control means includes a processor means including circuit board controls, a transformer for converting AC current to DC current, Wi-Fi communication means, General Packet Radio Service (GPRS) means and/or Global Positioning System (GPS) means; and wherein the control tower and tank are modular units that can be assembled to meet desired requirements and or provide replacement units.

The control tower preferably has a stop switch operatively connected to the motor so that if the motor overheats the stop switch automatically shuts off the power to the motor, thereby preventing damage to the motor or the processor means. The stop switch preferably serves as an inline fuse in this regard. The stop switch preferably serves a reset button to allow restarting of the motor. Preferably the stop switch is located on the outside of the control tower. Preferably the stop switch is located on the side of the control tower. The AC power socket is preferably located flush on the side of the control tower. The antenna is preferably located recessed on the side of the control tower.

Preferably the pipe or coupling extending from the sump is in fluid communication with the pump. The pump preferably pumps the filtered oil from the sump through to the hose for discharging.

Preferably the tank is adapted to allow tank to be positioned under an oil drain of an oil source to facilitate drainage of the used oil from the oil source directly into the inlet.

Preferably the tank is secured to the control tower by one or more bolts.

The tank can preferably be selected from a plurality of different sizes and shapes, the size of the tank is selected with reference to the volume of the used oil to be filtered and the shape of the tank is selected with reference to the available space where the apparatus is to be operated.

The length, width and height of the tank are selected with respect to the volume of oil to be filtered and the available space under an oil drain of the oil source. Preferably the tank has a substantially rectangular shape. In other embodiments the tank can have an alternative shape to allow it to fit in small or awkward spaces. Alternatively the tank can have a substantially rectangular shape with a substantially curved, tapered or pointed front end.

The tank preferably includes a tank with an opening that can be positioned adjacent an outlet of the oil source to allow used oil to flow directly into the tank.

The oil filtering apparatus more preferably has at least two wheels enabling the apparatus to be manoeuvrable.

The pump means preferably includes a hose member which is operationally connected to the tank via the pump.

Said oil source is preferably cooking oil reservoirs. More preferably the oil source is a deep fryer or cooker.

In another aspect, the invention broadly resides in a method for removing oil from an oil source for filtering for re-use, using the abovementioned apparatus, said method including:

positioning said portable oil filtering apparatus adjacent the oil source outlet so that oil discharged from the outlet enters said tank means;

opening the oil source outlet to allow oil to discharge into the tank and through the filter means;

closing the oil source outlet after the oil has discharged; and

activating the pump means to reintroduce the filtered oil into the oil source.

The method can also include the step of using the filtered oil to wash any residual particulate matter from the oil source prior to refilling the oil source.

### BRIEF DESCRIPTION OF THE DRAWINGS

In order that the present invention can be more readily understood and put into practical effect, reference will now be made to the accompanying drawings wherein:

FIG. 1 shows a diagrammatic front view of the preferred embodiment of the portable oil filter apparatus;

FIG. 2 is a top view of the preferred embodiment of the portable oil filter apparatus;

FIG. 3 is a side view of the preferred embodiment of the portable oil filter apparatus;

FIG. 4 is a rear diagrammatic view of the preferred embodiment of the portable oil filter apparatus;

FIG. 5 is an exploded view showing the modular nature of the tank and control tower of the preferred embodiment of the portable oil filter apparatus with the lid in a closed position;

FIG. 6 is a cut-away view of the tank showing the sump grate in the interior of the tank;

FIG. 7 is diagrammatic view of the frame of a filter frame;

FIG. 8 is a diagrammatic view of the polymer filter;

FIG. 9 is a diagrammatic view of two nested polymer filters;

FIG. 10 is a diagrammatic view showing a polymer mesh filter and an oil filter apparatus;

FIG. 11 is a diagrammatic view showing a polymer mesh filter positioned in the top opening of the oil filter apparatus

FIG. 12 is a side view of the control tower;

FIG. 13 is a rear sectional view of the control tower;

FIG. 14 is a plan view of the touch control panel; and

FIG. 15 shows an alternative embodiment of the oil filter apparatus showing a filter grate in the top opening of the tank.

### DETAILED DESCRIPTION OF THE PREFERRED EMBODIMENT

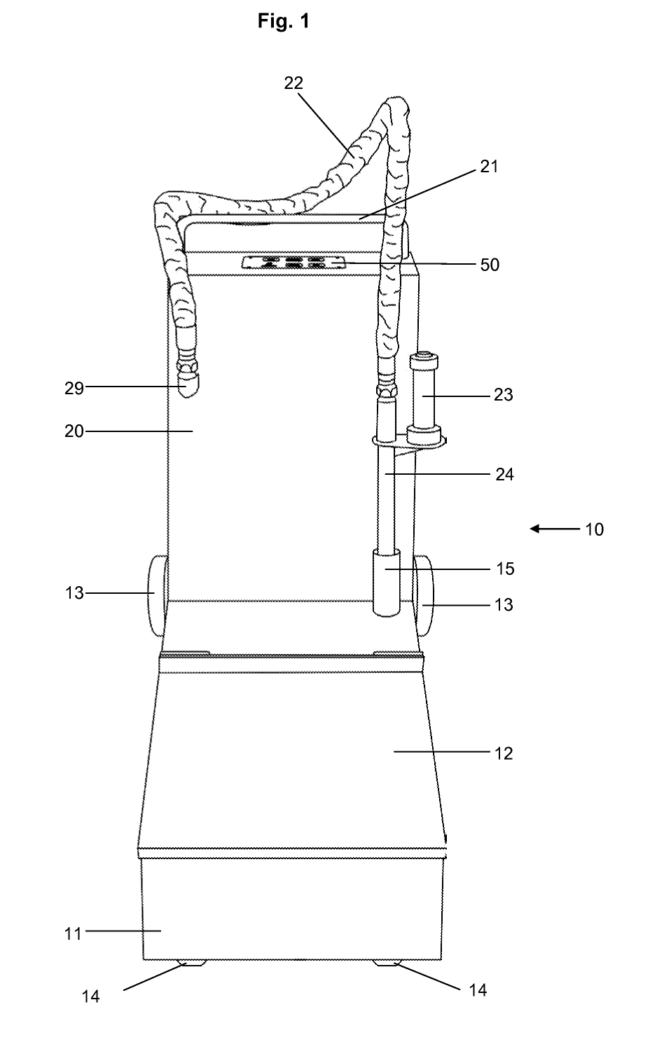

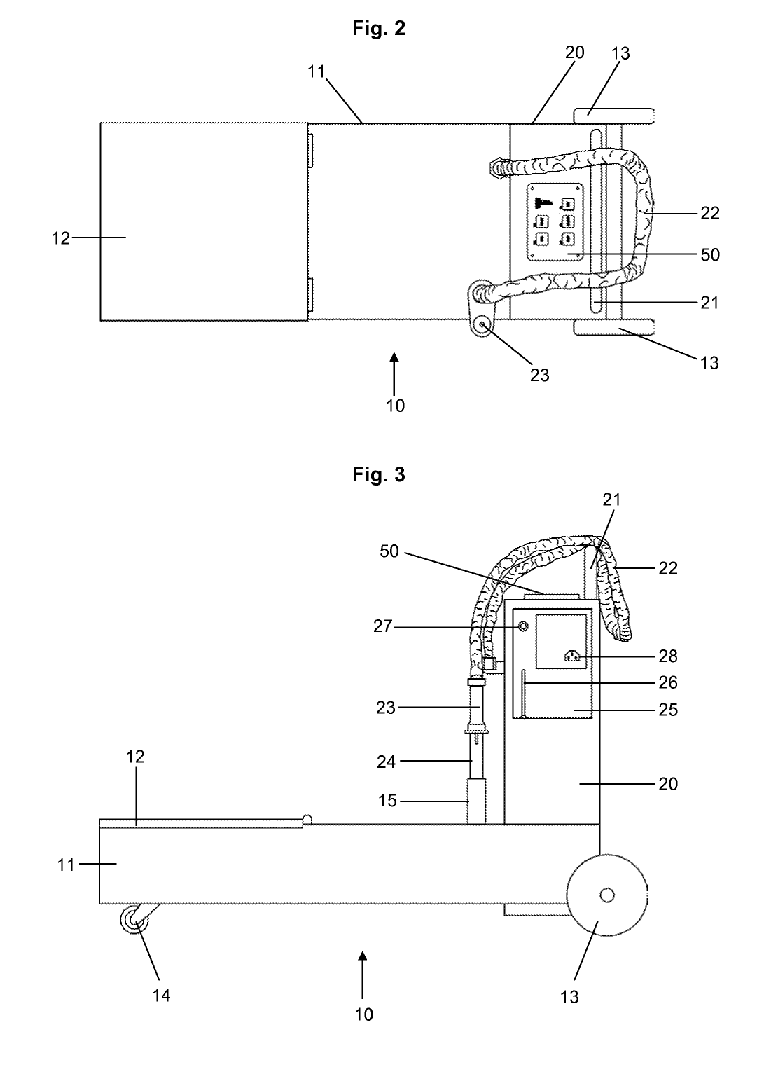

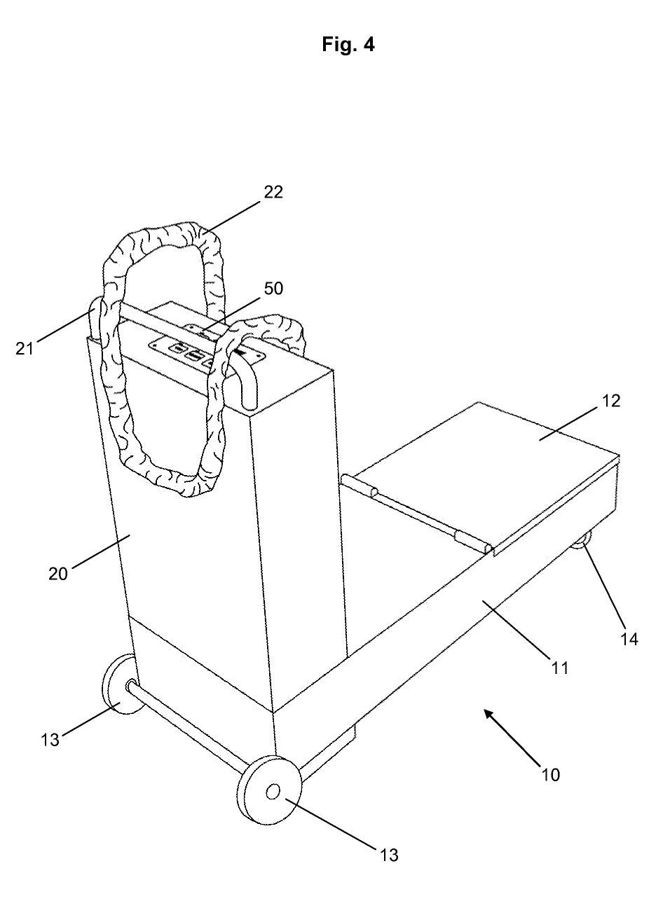

With reference to the FIGS. 1 to 6 there is shown a portable oil filter apparatus 10 in accordance with a preferred embodiment. The oil filter apparatus 10 can be used to receive used cooking oil from a fryer, filter the oil and return the filtered oil back to a fryer.

The oil filter apparatus 10 includes a tank 11 and a control tower 20. The tank 11 and control tower 20 are made from steel.

The tank 11 has a tank inlet 18 with a hinged lid 12. The tank inlet 18 receives used oil for filtering. The tank 11 is fitted with a pair of rear wheels 13 and a pair of front swivel wheel 14. The wheels 13, 14 provide the oil filter apparatus 10 with mobility and front swivel wheel 14 enables the oil filter apparatus 10 to be manoeuvred into a desired position. There is a handle 21 mounted on the upper surface of the control tower 20 to assist in moving the oil filter apparatus 10.

There is a discharge outlet 29 on the control tower 20. The discharge outlet 29 is fitted with a flexible hose 22 with a nozzle 24 and a handle 23 to direct the flow of filtered oil. The flexible hose 22 is coated with a sleeve of thermally stable plastic material to provide grip and protection against heat and spillages. The nozzle 24 is shown being stored in the nozzle holder 15 located on the upper surface of the tank 11.

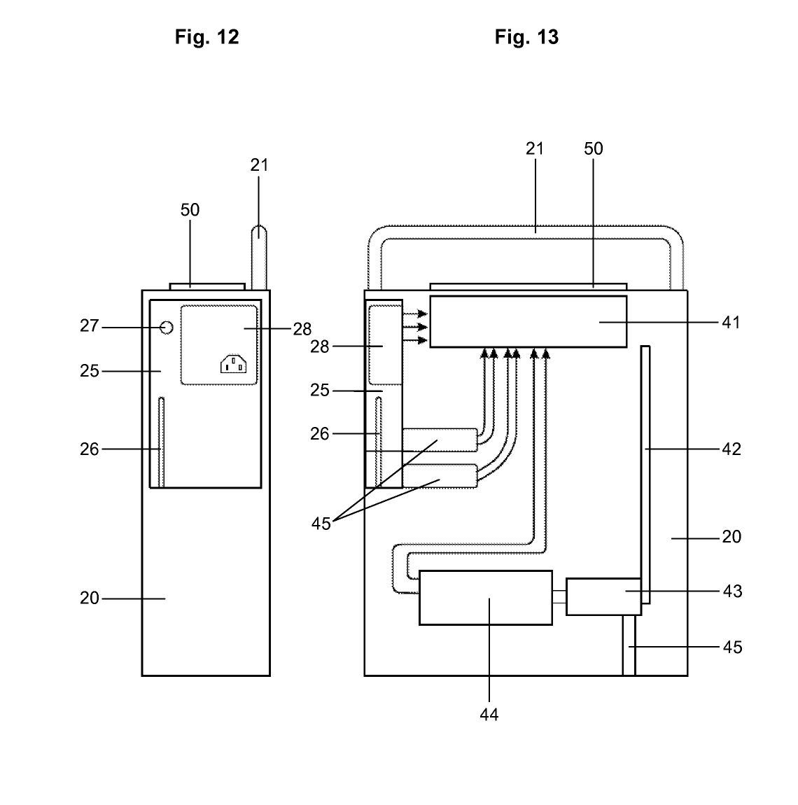

With reference to FIGS. 12 and 13 there is shown features of the control tower 20. The control tower 20 has a recessed portion 25 on one side which accommodates an antenna 26, a motor stop button 27 and an AC mains socket 28. The control tower 20 has an enclosed section which houses an electrical pump 43 operationally connected to a heat resistant DC electric motor 44. The motor 44 is operationally connected to a processor unit 41. The processor unit 41 includes circuit board controls, a transformer for converting AC current to DC current, Wi-Fi communication means, General Packet Radio Service (GPRS) means and Global Positioning System (GPS) means. The processor unit 41 is also operatively connected to rechargeable batteries 45, mains socket 28, antenna 26 and stop button 27.

The processor unit 41 is operatively connected to the antenna 26. The processor unit 41 includes Wi-Fi communication means, General Packet Radio Service (GPRS) means and Global Positioning System (GPS) means. The GPS connectivity allows the location of the apparatus to be monitored. The GPRS connectivity (SIM card) and/or Wi-Fi connectivity provide remote access to the oil filter apparatus 10 by internet and/or telephone. Preferably the oil filter apparatus uses Wi-Fi communication in preference to using a telephone connection using a SIM card.

This allows apparatus monitoring, troubleshooting and diagnostic procedures to be carried out remotely. The processor unit 41 can be programmed to contact the oil filter apparatus supplier using the Wi-Fi and/or GPRS means, for example in the event of a malfunction occurring or if the battery charge becomes too low. The oil filter apparatus 10 can also be turned off remotely.

The processor unit 41 also includes recording means that can be programmed to continually record details of the operation of the oil filter apparatus 10 in association with its location (based on the GPS data) and the local time. By recording each operation of a button on the touch control panel 50, the processor unit 41 can log details such as when the oil filter apparatus is on, use of the filtering and backwash functions and the pump speed. The processor unit 41 can also log details relating to the battery charge level, activation of a low battery alarm and charging of the battery. Details of the oil filter apparatus activity, including all operations of the controls, can be retained as an operations log for a 28 day period. This log can be accessed remotely via Wi-Fi or GPRS connectivity.

The operations log provides a convenient way to provide an accurate record of the use of the oil filter apparatus 10 and the details of the operations carried out. This function provides documentation to verify to any relevant authority (such as HACCP or other food safety or food standards Authority) that cooking oil has been cleaned by filtering in accordance with applicable regulations or guidelines. The operations log can also provide information to the supplier of the oil filter apparatus, or by the owners or management of the kitchen. This information can be used by kitchen management to ensure that the cooking oil is being cleaned to maintain quality and that frying facilities in the kitchen are being operated economically and efficiently. The operations log also allows the supplier of the oil filter apparatus to ensure that the oil filter apparatus is being operated properly and determine if further training is required. The remote access to the oil filtering apparatus allows remote support to identify if there is a problem, what is the problem. and offer a solution to the problem. The remote access also allows remote support to shut down the oil filtering apparatus for safety or management reasons.

The enclosed control tower 20 offers protection against oil spillage and allows the oil filter apparatus 10 to be washed down with, for example, a fire hose.

The oil filter apparatus 10 is controlled by operation of a touch control panel 50 mounted on the upper surface of the control tower 20. The touch control panel 50 is durable and resilient and resistant to water and oils.

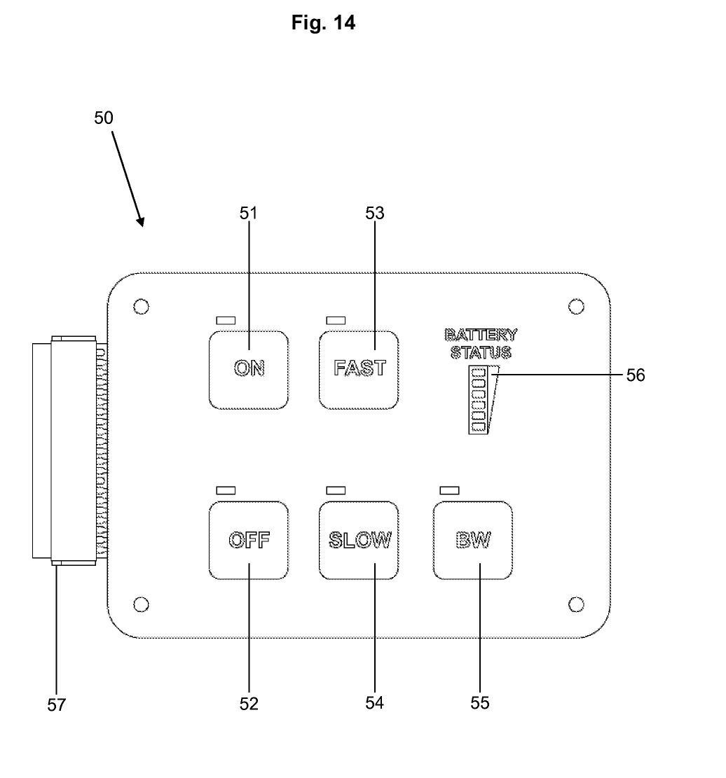

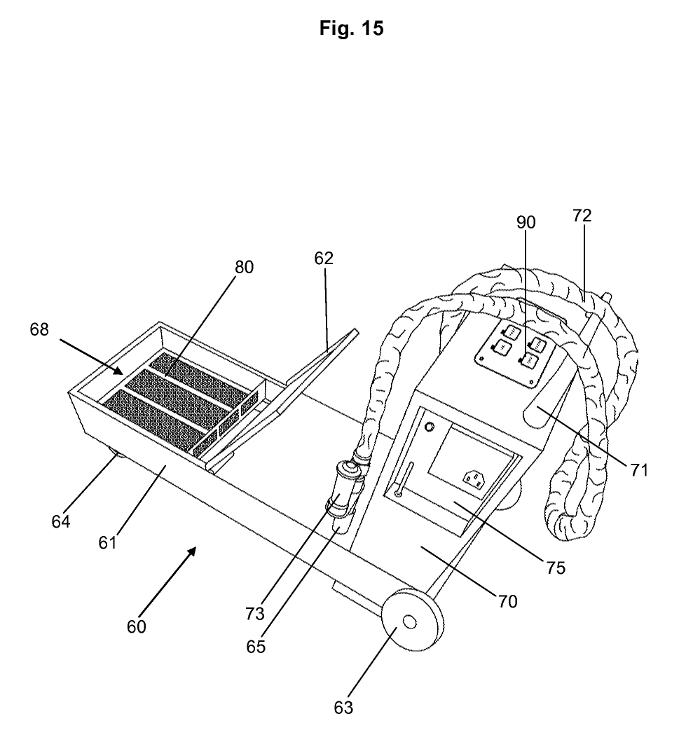

The touch pad control panel 50 is operatively connected to the processor unit 41. With reference to FIG. 14, the touch pad control panel 50 has an “on” button 51 to turn the power supply to the portable oil filter apparatus 10 on. It does not turn on the pump. The “off” button 52 is pressed to turn the power supply to the apparatus off. The battery status indicator 56 indicates the battery level. The unit will be turned off and an alarm activated when the battery level drops below a predetermined value (usually 11.2v). The “slow” button 54 is depressed to start the pump. This typically produces an oil flow rate of approximately 12 litres per minute. A faster flow (typically 25 litres per minute) can be obtained by activating the “fast” button 53. The motor can be reversed by depressing the “BW” button 55. This feature provides a backwash facility to allow the pump to be flushed out if it becomes blocked. The backwash facility only operates if the operator's finger remains on the button to keep it in the depressed position, thus preventing misuse of the apparatus.

The motor 44 will operate on DC or AC power. When the motor is connected to mains electricity the unit will operate on AC. The processor unit 41 will divert a portion of the mains current to charge the rechargeable batteries 45. With mains power disconnected, the circuit board will operate on DC from the batteries.

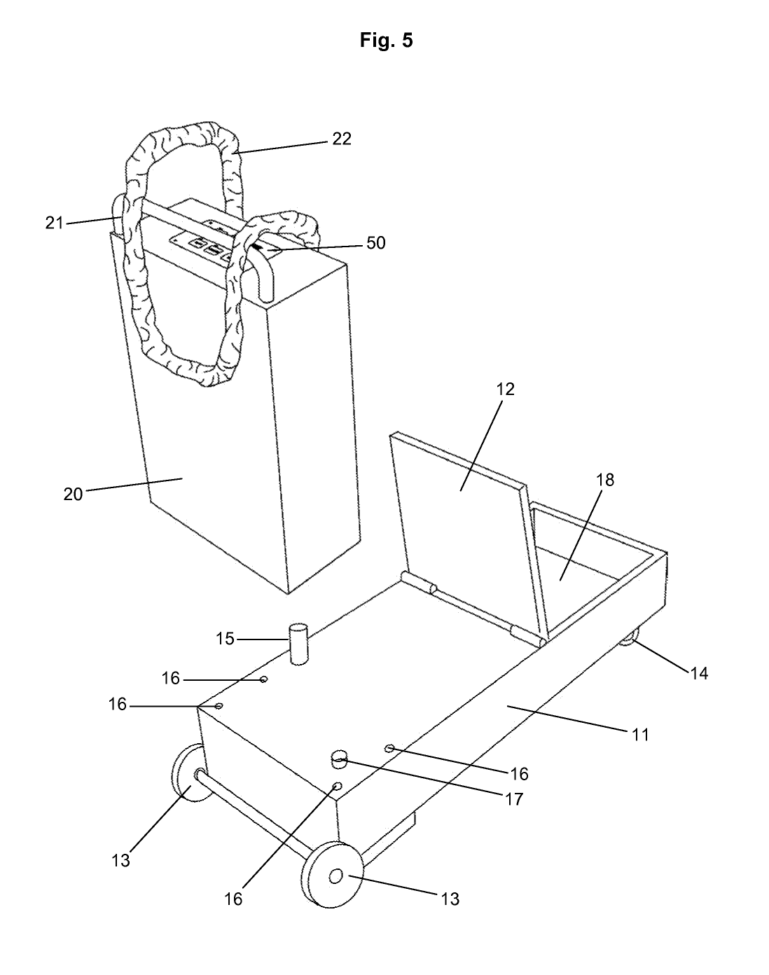

With reference to FIG. 5, there is demonstrated the modular nature of the oil filter apparatus 10. The control tower 20 is secured to the rear upper surface of the tank 11 by four bolt connections 16. The bolt connections 16 facilitate rapid replacement of the control tower 20 if necessary for servicing, upgrading or in case of malfunction. The ability to rapidly replace the control tower 11 minimises downtime of the oil filter apparatus 10. The bolt connection allows the tank 10 to be exchanged quickly. This allows rapid interchange of tanks to provide a different sized or shaped tank in accordance with requirements.

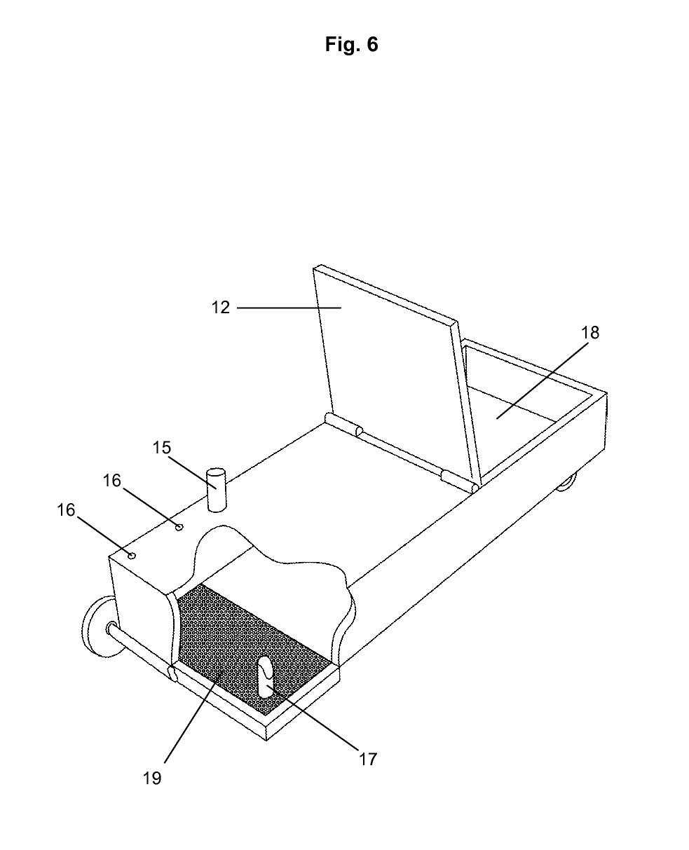

With reference to FIG. 6 there is shown a cut-away drawing of the tank showing the tank interior and the tank outlet 17. The tank outlet 17 is in operative connection with a tank sump (not shown). The tank outlet 17 is in operative connection with the pump and the discharge outlet. The tank sump is covered by a removable sump grate 19. The sump grate 19 is a steel sheet with 1.5 mm perforations. This sump grate 19 protects the pump by preventing debris entering the sump and being sucked into the pump. The sump grate 19 is removable for cleaning purposes.

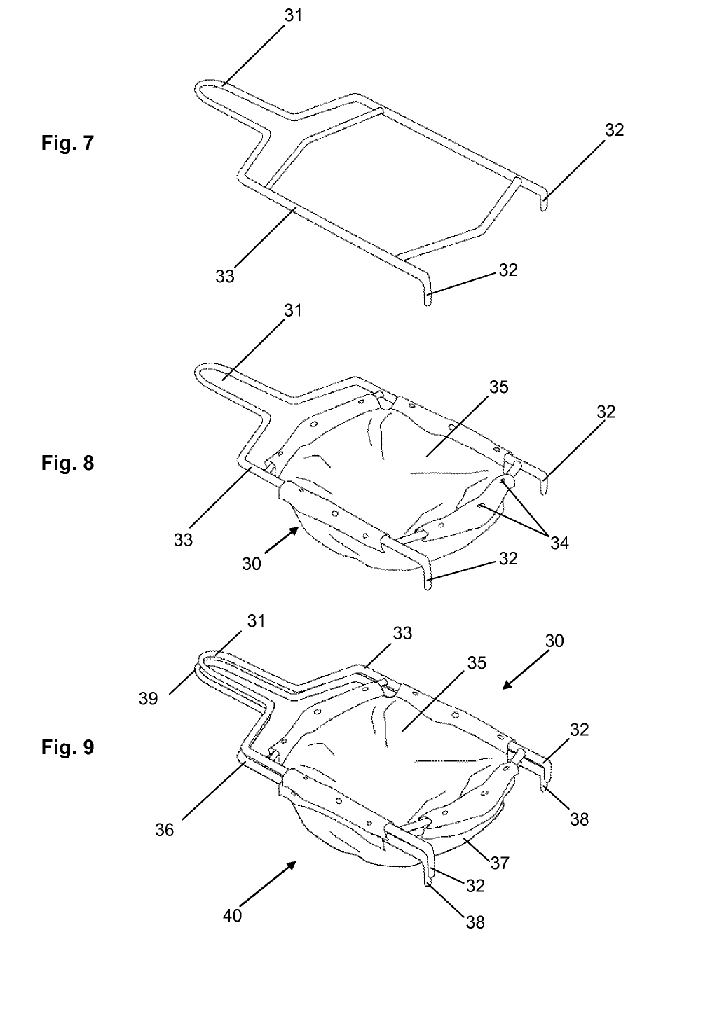

With reference to FIGS. 7 and 8 there is shown polymer mesh filter 30 including a polymer mesh bag 35 mounted on a filter frame 33 and fixed in position by snap fit fasteners 34. The polymer mesh is made from Teflon®. The polymer mesh filter 30 serves to retain particulate matter from the used oil that is larger than the pore size of the polymer mesh bag. The filter frame 33 has a handle 31 at one end of the frame 33 and two hooks 32 at the opposite end. Preferably the polymer mesh bag 35 has a mesh size of from 60 microns to 100 microns.

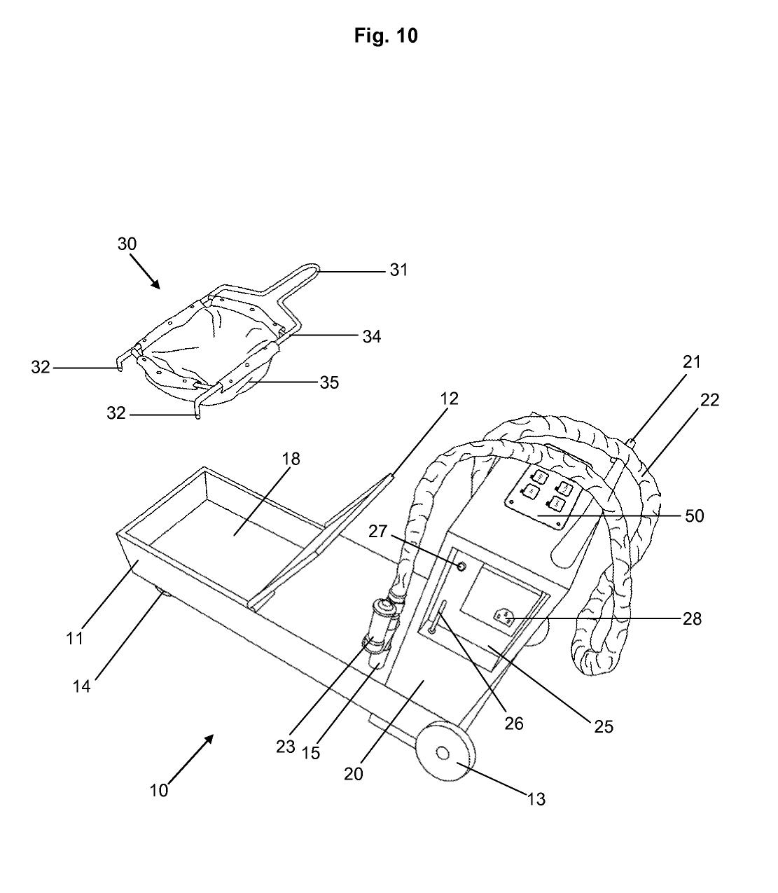

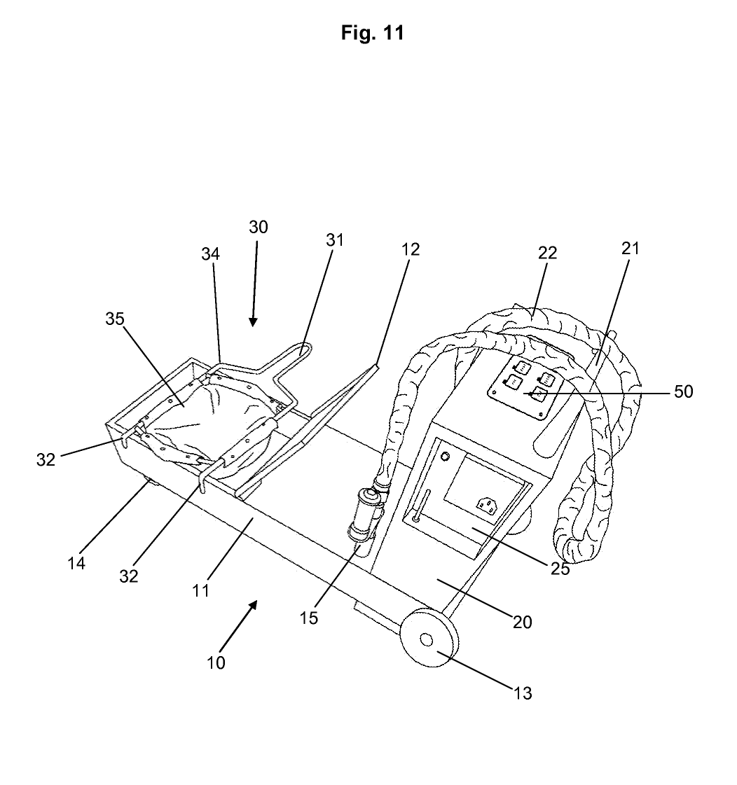

With reference to FIGS. 10 and 11, in use, the frame 33 is positioned on and over the tank inlet 18. The two hooks 32 cooperate with an edge of the tank inlet 18 to secure the frame in position and the filter bag 35 extends within the interior of the tank 11.

Where additional filtration is required, for example to remove fine particulate matter such as carbon, a second polymer mesh filter 40 is positioned on the outside of the first polymer mesh filter 30. The second polymer mesh filter 40 is similar to polymer mesh filter 30. It includes a frame 36, a filter bag 37, two hooks 38 and a handle 31. With reference to FIG. 9, the first polymer mesh filter 30 and the second polymer mesh filter 40 are shown stacked in a nested configuration with the first polymer mesh filter 30 uppermost. The second polymer mesh filter bag 37 is preferably slightly larger in size than the first polymer mesh filter bag so that they nest easily. Preferably the mesh size of the second polymer mesh bag 37 is the same as, or is smaller than, the pore size of the initial polymer filter. Preferably the second polymer mesh filter bag 37 has a pore size of approximately 60 microns.

Alternative forms of filter means can be used in conjunction with the present invention.

With reference to FIG. 15 there is shown an alternative embodiment of the oil filter apparatus 60. Oil filter apparatus 60 is substantially similar to oil filter apparatus 10, except that it is adapted to use paper filters instead of polymer mesh filters. FIG. 15 shows an oil filter apparatus 60 including a tank 61 with a hinged lid 62, a tank inlet 68, wheels 63,64, nozzle holder 65 and a control tower 70. The control tower 70 has a handle 71, flexible hose 72, a recessed portion 75 and touch control panel 90. The flexible hose 72 is attached to the discharge outlet (not shown). The hose 72 has a handle 73 and a nozzle. There is a filter grate 80 located in the tank inlet 68. This filter grate 80 can be used in conjunction with a paper filter (not shown).

Paper filters are useful in situations where it is desirable to use a filter aid such as diatomaceous earth when filtering the used cooking oil. The filter aid can be added cautiously to the hot oil at approximately 120° C. before filtering through the filter paper. Alternatively the filter aid can be formed into a filter pad resting on the filter paper.

Other forms of support for paper filters can be used in conjunction with the present invention.

In use, used oil from deep fryers or cookers can be safely collected for disposal or storage and/or filtered for re-use. To remove the oil, the cooker or deep fryer is switched off and the oil is allowed to cool. When the oil has sufficiently cooled, the valve associated with the outlet of the cooker or fryer is opened and oil is allowed to discharge into the tank inlet 18 of the tank 11. Discharged oil passes into the tank inlet 18 and is filtered by the polymer mesh filter 30. The polymer mesh filter 30 collects particulate matter including batter pieces and bread crumb waste.

When the oil has discharged the outlet valve can be closed and the polymer mesh filter 30 removed so that the collected particulate matter can be discarded. The filtered oil can be removed from the tank 11 by activating the pump 43. This will suck the filtered oil from the tank 11 through a tank outlet 45 to the pump 43 and on to the discharge outlet 29. The filtered oil can then be discharged through the hose 22 and nozzle 24 back into the fryer.

The oil filter apparatus 10 is preferably switched to slow flow rate mode when the cookers and deep fryers are washed down with oil to remove matter from the sides and bottom of the equipment. This reduces the likelihood of oil being splashed outside of the equipment. When the cleaning is finished, the switch is preferably turned to fast flow rate mode to enable the cooker and fryer to refill quickly. The fast flow rate mode is preferably used to discharge the oil from the apparatus for waste disposal. The oil from the apparatus may be discharged into drums for disposal purposes. Using a flow rate switch and changing the flow rate to provide safe and efficient handling of the oil can effectively reduce the time for filtering and cleaning oil from cookers and fryers.

Removal of particulate matter from the oil will reduce the rate of saturation, and thus the degradation, of the oil, thus extending the operational life of the oil.

### Advantages

The preferred embodiment of the present portable oil filtering apparatus has the advantage that it is resistant to oil spillages and is durable. The oil filtering apparatus is substantially sealed, so it can be hosed down with water.

The oil filtering apparatus is modular. This provides reduced down time if the control tower fails or when repairs or servicing of the apparatus is required. A replacement control tower can quickly and simply be attached to the tank. Alternatively a different size, shape or volume tank can be attached to the control tower. The modular nature of the oil filter apparatus of the present invention means that a suitable apparatus can be quickly and easily assembled to meet desired requirements with respect to oil volume, filtration means and operative controls.

In a preferred embodiment, the portable oil filtering apparatus is fitted with Wi-Fi, GPS and GPRS connectivity. These features provide location information, and allow monitoring and diagnostic procedures to be carried out remotely.

In a preferred embodiment the portable oil filtering apparatus can be adapted to provide an accurate record of the operations carried out. This feature provides suitable documentary records to verify that cooking oil has been maintained in accordance with regulations or guidelines set by food safety or food standards authorities.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1. A portable oil filtering apparatus for use for filtering oil from an oil source including:
a tank with a plurality of wheels; said tank has an inlet for receiving used oil from an oil source, a filter means to filter the used oil and a discharge outlet for discharging the filtered used oil;
a control tower mountable to the tank; said control tower has a pump means to pump the filtered oil from the tank discharge outlet and a control means to control the operation of the pump means;
wherein the control means includes two separate power means to power the pump means, a first power means includes at least one battery operationally connected to the pump means and a second power means includes a mains power connection via a transformer to the pump means; wherein the control tower and tank are modular units that can be assembled to meet desired requirements and or provide replacement units.

2. A portable oil filtering apparatus according to claim 1 wherein the control tower is mountable to the rear of the tank and is operatively associated with each other when the tank discharge outlet is operatively connected to the pump means.

3. A portable oil filtering apparatus according to claim 1 wherein the filter means includes one or more filters at or adjacent an opening of the inlet, and the filter means includes a frame with a heat resistant polymer mesh filter having 60 to 100 micron pore size.

4. A portable oil filtering apparatus according to claim 1 wherein the tank has a sump and the sump is separated from the rest of the tank by a sump grate.

5. A portable oil filtering apparatus according to claim 1 wherein the tank has a sump and the sump is separated from the rest of the tank by a sump grate, the tank discharge outlet includes a pipe that extends from the sump and is operatively connected to the pump means.

6. A portable oil filtering apparatus according to claim 1 wherein the pump means includes a DC electrical motor operatively connected to a pump.

7. A portable oil filtering apparatus according to claim 1 wherein the second power means transforms AC current from mains power to DC current to operate the pump means and charge the at least one battery, the pump means includes a DC electrical motor operatively connected to a pump.

8. A portable oil filtering apparatus according to claim 1 wherein the control means includes Wi-Fi communication means, General Packet Radio Service (GPRS) means and/or Global Positioning System (GPS) means.

9. A portable oil filtering apparatus according to claim 1 wherein the control means includes processor means actuated by a touch pad.

10. A method for removing oil from an oil source for filtering for re-use, using a portable oil filtering apparatus according to claim 1, said method including:
positioning said portable oil filtering apparatus adjacent the oil source outlet so that oil discharged from the discharge outlet enters said tank means;
opening the oil source outlet to allow oil to discharge into the tank and through the filter means;
closing the oil source outlet after the oil has discharged; and
activating the pump means to reintroduce the filtered oil into the oil source.
